(19) United States
(12) Patent Application Publication
(10) Pub. No.: US 2010/0288273 A1
(43) Pub. Date: Nov. 18, 2010

(54) Firefighter Hood for a Firefighter's Face Mask

(76) Inventor: Jacob Sandlin, Pasadena, TX (US)

Correspondence Address: CHARLES W. HANOR, P.C., 750 Rittiman Road, SAN ANTONIO, TX, 78209, US

(21) Appl. No.: 12/467,415

(22) Filed: May 18, 2009

(51) Int. Cl. A62B 18/00; A62B 17/04

(52) U.S. Cl. 128/201.24; 2/7

(57) ABSTRACT

A firefighter's fire resistant hood designed for attachment to a firefighter's fire resistant mask using a fastening means to form a seal between the firefighter's fire resistant hood and firefighter's fire resistant mask thereby preventing injury to the firefighter's head, face, neck, shoulders and back. The firefighter's fire resistant hood comprises a head portion and a shoulder portion. The head portion has a face opening. The inner periphery of the face opening contains a securing means to interface with another securing means on the mask element thus removably attaching the two elements.

### STATEMENTS REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

The present invention is a firefighter fire resistant hood for a mask to provide improved protection to a firefighter's face, head and neck during various firefighting scenarios especially interior structure fires where the heat generated by the fire is often the cause of facial and other types of burns and injuries and death for firefighters.

Firefighter gear is designed to provide the firefighter protection from the intense heat associated with all firefighting, especially interior fires. For an interior fire, a typical firefighting ensemble includes fire boots, fire pants, a fire coat, fire gloves, a face mask, a Self Contained Breathing Apparatus (SCBA), fire hood and a hard hat fire helmet. This equipment is constructed from fire resistant materials such as Nomex® brand. This firefighter gear typically protects firefighters from many of the dangers of interior firefighting including intense heat, flashovers and smoke explosions. In particular, a firefighter's hood should protect a firefighter's face and neck in the areas where the firefighter's mask does not cover.

Prior art attempts to provide neck and face protection for firefighters have failed to provide a tight coupling between the firefighter's hood and the firefighters mask. While a firefighters hood may appear to be tightly coupled with the firefighter's mask when the firefighter first places the hood over their head, slipping and bunching often occurs as the firefighter adds additional gear to their ensemble. A known prior art firefighter's hood includes hood made of fire resistant fabric materials and a releasable flap at the front to allow placing it over a firefighter's mask. This hood includes an opening for the fire fighter's mask. Another known prior art firefighter's hood is an stretchable hood that easily stretches to allow positioning it over a fire fighter's mask. This hood also includes an opening for the fire fighter's mask. A hard firefighter's helmet is typically worn on top of a hood.

Tightening the chin strap of the firefighter's helmet may cause bunching of a conventional hood between the face mask and the hood. This bunching can lead to gaps which present a burn risk to the firefighters Because firefighters must dress very quickly when they respond to a fire, slight gaps between the firefighter's mask and hood often go unnoticed. As a result firefighters often suffer from steam burns on their cheeks where the coupling between their face mask and hood gives way.

Many firefighters elect to wear two hoods to provide more complete facial coverage. Firefighters who do this will wear one thin skintight hood as well as one looser fitting hood. While wearing two hoods does provide additional coverage, it is still not designed to prevent facial burns that occur from heat that reaches the firefighters face through the gap between the hoods and the face mask. Moreover, firefighters need to dress extremely fast once they have been called to action and putting on two hoods requires additional time.

The National Fire Protection Association (NFPA) promulgates standards for firefighter safety. The present invention is designed to meet NFPA standards and the Texas Commission of Fire Protection. Initial testing indicates that the invention provides better protection to a fire fighter than prior art hoods.

### SUMMARY OF THE INVENTION

One object of the present invention is to provide an improved protective firefighter hood and mask with fasteners to provide for coupling between a firefighter's mask and the firefighter's hood.

Another object of the present invention is to provide an improved protective firefighter hood and mask design to minimize the risk of firefighter facial burns and death.

Yet another object of the present invention is to provide an improved protective firefighter hood which provides additional coverage for the shoulders of firefighters.

An additional object of the present invention is to provide an improved protective firefighter hood which provides firefighters with the option of leaving the hood outside the collar of their firefighting jackets.

Another object of the present invention is to reduce the average amount of time it takes for a firefighter to don and properly position his firefighting gear.

These and other objects are attained in accordance with the present invention which comprise of a hood element for attaching to a mask element. The hood element comprises of a head portion, a shoulder portion joined to the head portion at the neck join and a face opening in the head portion of the hood element. The mask element comprises a traditional firefighter mask which is adapted for attachment to the hood element.

The hood element of the present invention is constructed using a conventional fire resistant fabric such as Nomex® brand. The head portion provides protection to the head, face, and neck of the firefighter and the shoulder portion provides protection to the neck, shoulders, back and chest of the firefighters The edge of the face opening contains a means for removably affixing the hood element to the mask element, such as hook and loop fasteners or snaps.

The mask element of the present invention comprises a traditional firefighters mask adapted for connection to the face opening of the hood element. Such adaptation comprises a means for removably affixing the mask portion to the hood element such as Velcro® brand hook and loop fastens or snaps. The fasteners are secured to the edges of the mask in such a manner as to provide a close and tight connection between the mask element and the hood element.

The National Fire Protection Association (NFPA) promulgates standards for firefighter safety. The present invention is designed to meet NFPA standards and the Texas Commission of Fire Protection. Initial testing indicates that the invention provides better protection to a fire fighter than prior art hoods.

### BRIEF DESCRIPTION OF THE DRAWINGS

FIG. 1 is a perspective front view of the hood and mask elements of one embodiment the present invention;

FIG. 2 is a perspective front view of the mask element of one embodiment of the present invention;

FIG. 3 is an inside-out view of the hood element of one embodiment of the present invention;

FIG. 4 is a perspective front view of the hood element of the present invention;

FIG. 5 is a perspective rear view of the hood element of the present invention;

FIG. 6 is a perspective front view of the mask element of one embodiment of the present invention;

FIG. 7 is an inside-out view of the hood element of one embodiment of the present invention; and

FIG. 8 is a perspective front view of the hood and mask elements of one embodiment of the present invention.

### DETAILED DESCRIPTION OF THE PREFERRED EMBODIMENTS

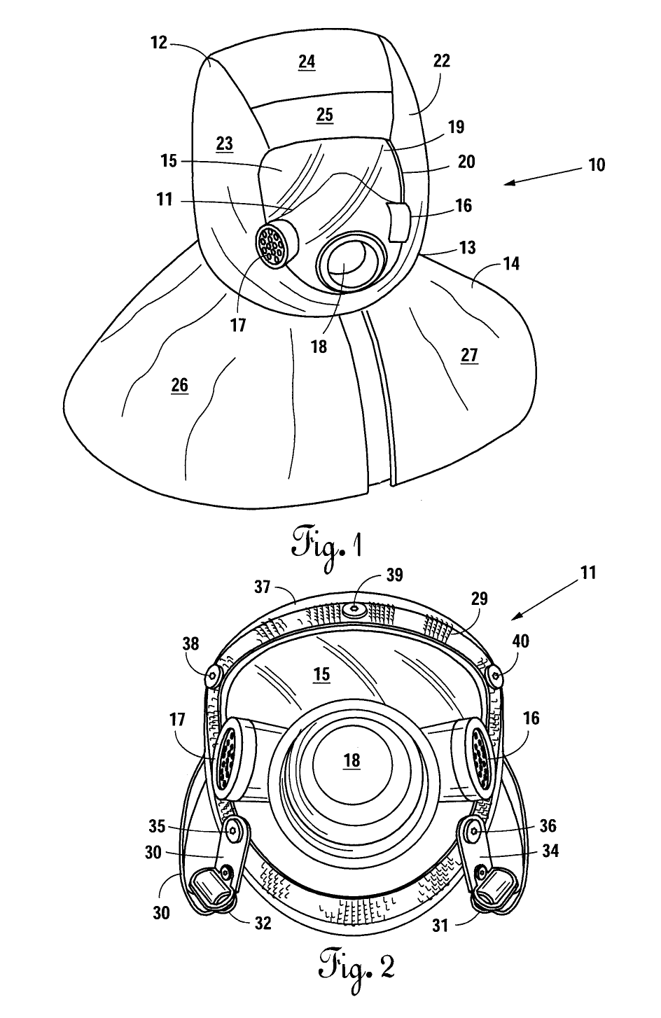

FIG. 1 shows the invention generally including both the fire resistant hood element 10 and the mask element 11. The fire resistant hood element 10 is comprised of multiple layers of Nomex® brand or other fire resistant fabric and is generally comprised of an integral head portion 12 and shoulder portion 14 attached to the head portion 12 at the neck join 13. The head portion 12 is shaped to accommodate the head and neck of the firefighters The shoulder portion 14 of the fire resistant hood element 10 is flared to accommodate the firefighter's shoulders. The head portion 12 and shoulder portion 14 are attached at the neck join 13. In the embodiment illustrated in FIG. 1, the shoulder portion 14 is designed to extend completely over and around the firefighter's shoulders as well as the firefighters back and chest. The integral shoulder portion 14 provides enough coverage to lay outside and on top of the firefighter's coat at the firefighter's option. It also can be tucked inside the coat. The mask element 11 is a standard firefighters mask or breathing device adapted to be removably securable and sealable to the fire resistant hood element 10.

The standard mask element 11 is comprised of a transparent face portion 15, two voice transmitters on either side of the mask 16 and 17, and an opening for insertion of a SCBA regulator 18. The head portion 12 of the fire resistant hood element 10 includes a face opening 19 to accommodate the mask element 11.

The conventional mask element 11 and new fire resistant hood element 10 are secured at the mask/hood interface 20 with fastener elements, the hood fastener 21 and the mask fastener 29. In one preferred embodiment, both fasteners 21 and 29 are Velcro® brand hook and loop fasteners. In another preferred embodiment, both fasteners 21 and 29 are snap fasteners.

In the preferred embodiment, the head portion 12 is comprised of integral panels of Nomex® brand or other fire resistant material stitched together using Nomex® brand or other fire resistant thread. The multiple layers of fire resistant material will resist high temperatures for a limited amount of time and protect the fire fighter from heat and burning. The panels comprising the head portion 12 of the fire resistant hood element 10 extend downwards to the neck join 13 of the fire resistant hood element 10 where they attach to the panels comprising the shoulder portion 14 of the fire resistant hood element 10. The shoulder portion 14 extends from the head portion 12 at the neck join 13 and flares outwards at a consistent angle from the neck join 13. In the embodiment illustrated in FIG. 1, the shoulder portion 14 of the fire resistant hood element 10 extends out at least six inches from the neck join 13 to cover the firefighter's shoulders and a portion of the firefighter's back and chest. The shoulder portion 14 of the fire resistant hood element 10 is comprised of panels of Nomex® brand or other fire resistant material stitched together using Nomex® brand or other fire resistant thread.

The panels comprising the head portion 12 of the hood element vary in size and are arranged in such a manner as to form the shape of the head portion 12 as described above. Two equal sized side panels 22 and 23 are placed on either side of the face opening and extend upward vertically where they join the top center panel 24 and the anterior top panel 25 and downward to the neck join 13 where they join the shoulder panels 26 and 27. The shoulder panels 26 and 27 and back panels form a continuous wrap around the shoulders, back and front of the firefighter so that there are no gaps that would allow exposure of the firefighter's head.

The top of the head portion 12 of the fire resistant hood element 10 is comprised of two panels 24 and 25. One top center 24 panel covers the majority of the top center of the head portion 12 of the fire resistant hood element 10, extending horizontally from the rear of the hood element toward the face opening 19 where it joins the anterior top panel 25 which extends downward to the face opening 19. The back section of the head portion 12 of the fire resistant hood element 10 is comprised of two equally sized back panels, the left back head panel 42 and the right back head panel 43. The left back head panel 42 joins the right side panel 22 of the head portion 12 vertically along the left edge, the top center panel 24 horizontally along the top edge of the left back head panel 42, the left shoulder back panel 44 of the shoulder portion 14 of the fire resistant hood element 10 horizontally along the bottom edge of the left back head panel 42 at the neck join 13, and the right back head panel 43 vertically along the right edge of the left back head panel 42. The right back head panel 43 joins the left side panel 23 of the head portion 12 vertically along the right edge, the top center panel 24 horizontally along the top edge of the right back head panel 43, the right shoulder back panel 45 of the shoulder portion 14 of the fire resistant hood element 10 horizontally along the bottom edge of the left back head panel 42 at the neck join 13, and the left back head panel 42 vertically along the left edge of the right back head panel 43.

The shoulder portion 14 of the fire resistant hood element 10 is comprised of four continuous panels with no gaps which extend from the neck join 13 where they are joined with the head portion 12. The shoulder panels are arranged about the fire resistant hood element 10 extending from the neck join 13. The two side shoulder panels 26 and 27 extend from where they are joined to the two side head panels 22 and 23 at the neck join 13. The fabric comprising the side shoulder panels 26 and 27 flares as it extends downward to accommodate the shoulders of the firefighters The two back panels of the shoulder portion 14 are the left back shoulder portion 44 and the right back shoulder portion 45. The back shoulder panels 44 and 45 are of a similar in size and dimension to the two back head panels 42 and 43. The left back shoulder panel 44 extends downwards from where it is attached to the left back head panel 42 at the neck join 13 of the fire resistant hood element 10. The left back shoulder panel 44 joins the left back head panel 42 horizontally at the top edge of the left back shoulder panel 44, the right shoulder panel 27 vertically on the left edge of the left back shoulder panel 44 and the right back shoulder panel 45 vertically along the right edge of the left back shoulder panel 44. The bottom of the left back shoulder panel 44 is hemmed and does not join with anything. The right back shoulder panel 45 extends downwards from where it is attached to the right back head panel 43 at the neck join 13 of the fire resistant hood element 10. The right back shoulder panel 45 joins the right back head panel 43 horizontally at the top edge of the right back shoulder panel 45 and the left back shoulder panel 44 vertically along the left edge of the right back shoulder panel 45. The bottom of the right back shoulder panel 45 is hemmed and does not join with anything. The two side shoulder panels 26 and 27 join each other under the face opening 19 of the head portion 12 of the fire resistant hood element 10 along the firefighter's sternum.

The hood fastener 21 is attached on the interior to the two side panels of the head portion 22 and 23, and the anterior top panel 25 using Nomex® brand or other fire resistant thread. The hood fastener 21 of the fire resistant hood element 10 is attached in an inward facing direction to facilitate interface with the mask fastener 29 of the mask element 11. In one preferred embodiment, both the hood fastener 21 and the mask fastener 29 are hook and loop fasteners such as Velcro® brand. In the alternate preferred embodiment, the hood fastener 21 and the mask fastener 29 comprise snap fasteners.

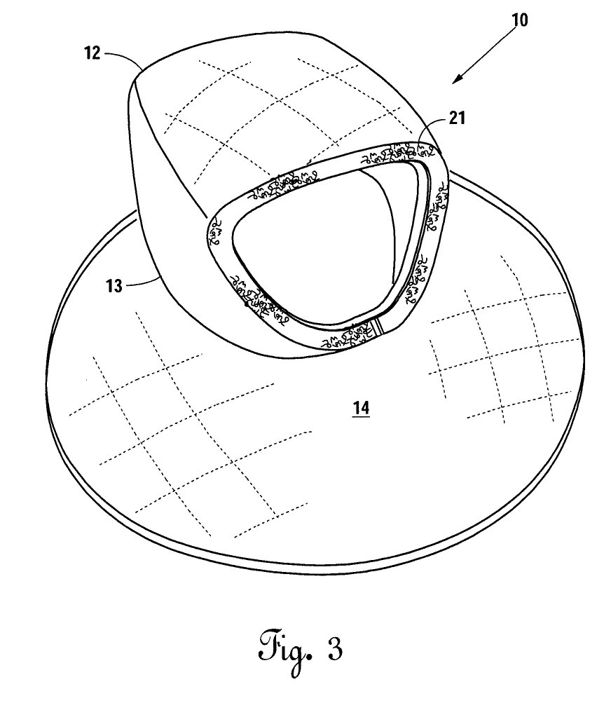

FIG. 2 shows the conventional mask element 11 of the preferred embodiment of the invention in detail. The mask element 11 comprises a transparent face portion 15, two voice transmitters 16 and 17 on opposite sides of the mask element 11, and an SCBA opening 18 for insertion of a SCBA regulator. The conventional mask element 11 comprises a new mask fastener 29 portion added which is affixed to the edge of the transparent face portion 15 of the mask element 11. The new mask fastener 29 for the mask element 11 interfaces with mating fasteners on the hood fastener 21 of the fire resistant hood element 10 at the mask/hood interface 20. The mask element 11 also encompasses a conventional mesh head harness which is not pictured and a head strap 30.

The transparent face portion 15 of the mask element 11 is constructed from conventional heat resistant plastic material to maximize both fire resistance and visibility. The head strap 30 is made adjustable by threading the head strap 30 through metal clips 31 and 32 which are affixed to both ends of the head strap 30. The metal clips 31 and 32 are affixed so that the clips can slide along the head strap 30 allowing the head strap's 30 length to be adjusted in a range from a full extension to fifty-percent therof. The head strap 30 is attached to the edge of the fire resistant face mask 37 using metal brackets 33 and 34 which are screwed into the face mask with metal screws 35 and 36. The edge portion 37 of the fire resistant mask is designed to create a seal with the firefighter's face to prevent smoke from reaching the firefighter's nose and mouth. The edge portion 37 of the fire resistant face mask is shaped to fit around the firefighter's face. Accordingly, the edge portion 37 is larger at the top forehead portion of the mask element 11 and narrows toward the bottom chin portion of the mask element. The edge portion of the mask 37 is overlapped by the transparent face portion of the mask 15 on the edges of the transparent face portion 15 where the mask fastener 29 is affixed around the entire edge of transparent face portion 15. A regulator and a conventional oxygen tank may be attached to the mask element 11 at SCBA opening 18 for extending breathing during exposure to smoke and other lung damaging conditions.

The head strap 30 is attached to the mask element 11 at the chin area of the mask element 11 using plastic and metal fasteners 35 and 36 which are permanently affixed through the lower chin portion of the mask element 11. The mesh head harness, which is not pictured, is attached to the mask element 11 using plastic and metal screws 38-40 which are permanently affixed through the upper forehead portion of the mask element 11. These screws also serve to attach the face mask edge 37 with the transparent face portion 15 of the mask element 11. The voice transmitters 16 and 17 are located on opposite sides of the SCBA opening 18 and are utilized to allow a firefighter to communicate through their mask.

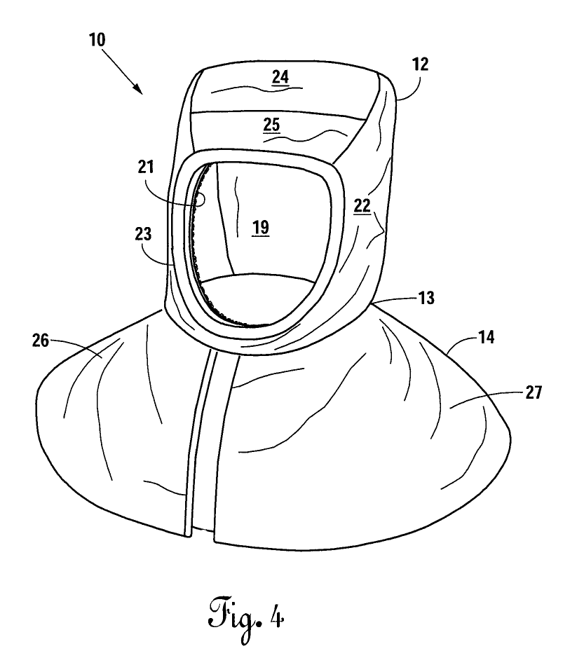

FIG. 3 shows an inside-out view of the fire resistant hood element 10. This figure shows the interior of the fire resistant hood element 10 comprising a fire resistant head portion 12 and a fire resistant shoulder portion 14 joined to the head portion 12 at the neck join 13. The head portion 12 of the fire resistant hood element 10 contains a face opening 19 to accommodate the fire resistant mask element 11 shown in FIG. 2. The inside-out view of the fire resistant hood element 10 as shown in FIG. 3 demonstrates the hood fastener 21. The hood fastener 21 interfaces with the mask fastener 29 to removably attach the fire resistant hood element 10 with the mask element 11 and seal and secure the mask with the hood. In the preferred embodiment, the interior of the hood element is lined with a lining of Nomex® brand or other fire resistant fabric 41.

FIG. 4 shows a frontal view of the fire resistant hood element 10. The figure shows the fire resistant hood element 10 comprising a head portion 12 and a shoulder portion 14 extending below the head portion 12 from the neck join 13. The head portion 12 of the fire resistant hood element 10 contains a face opening 19 to accommodate the mask element 11 shown in FIG. 2. The hood fastener 21 can be seen on the interior of the fire resistant hood element 10 through the face opening 19.

In the preferred embodiment, the head portion 12 is comprised of integral panels of Nomex® brand or other fire resistant material stitched together using Nomex® brand or other fire resistant thread. The panels comprising the head portion 12 of the fire resistant hood element 10 extend downwards to the neck join 13 of the fire resistant hood element 10 where they attach to the panels comprising the shoulder portion 14 of the fire resistant hood element 10. The neck join 13 is narrower than the head portion 12. The shoulder portion 14 extends from the neck join 3 and flares outwards at a consistent angle from the neck join 13. In the embodiment illustrated in FIG. 3, the shoulder portion 14 of the fire resistant hood element 10 extends out at least six inches from the neck join 13 to cover the firefighter's shoulders and a portion of the firefighter's back and chest. The shoulder potion 14 of the fire resistant hood element 10 is comprised of four panels of Nomex® brand or other fire resistant material stitched together using Nomex® brand or other fire resistant thread.

The panels of the head portion 12 of the hood element vary in size and are arranged in such a manner as to form the shape of the head portion 12 as described above. Two equal sized side panels 22 and 23 are placed on either side of the face opening and extend upward vertically where they join the top center panel 24 and the anterior top panel 25 and downward to the neck join 13 where they join the shoulder panels 26 and 27. The top of the head portion 12 of the fire resistant hood element 10 is comprised of two panels 24 and 25. One top center 24 panel covers the majority of the top center of the head portion 12 of the fire resistant hood element 10, extending horizontally from the rear of the hood element toward the face opening 19 where it joins the anterior top panel 25 which extends downward to the face opening 19. The back section of the head portion 12 of the fire resistant hood element 10 is comprised of two equally sized back panels, the left back head panel 42 and the right back head panel 43. Each back head panel 42 and 43 joins a side panel 22 and 23 vertically along one edge, the top center panel 24 horizontally along the top edge, the shoulder portion 14 of the fire resistant hood element 10 horizontally along the bottom edge at the neck join 13, and the other back panel, vertically along one edge.

The shoulder portion 14 of the fire resistant hood element 10 is comprised of integral and continuous panels which extend from the neck join 13 where they are joined with the head portion 12. The shoulder panels are arranged about the fire resistant hood element 10 extending from the neck join 13. The two side shoulder panels 26 and 27 extend from where they are joined to the two side head panels 22 and 23 at the neck join 13. The fabric comprising the side shoulder panels 26 and 27 flares as it extends downward to accommodate the shoulders of the firefighter. The two back shoulder panels 44 and 45 of the shoulder portion 14 are of a similar in size and dimension to the two back head panels 42 and 43 of the head portion 12. The two back shoulder panels 44 and 45 extend downward from where they are attached to the two back head panels 42 and 43 of the head portion 12 at the neck join 13 of the fire resistant hood element 10. Each back shoulder panel 44 and 45 joins a back head panel 42 and 43 horizontally at the top, a side shoulder panel 26 and 27 vertically on one side and the other back shoulder panel vertically on the other side. The bottom of each back shoulder panel 44 and 45 is hemmed and not joined with anything. The two side shoulder panels 26 and 27 join each other under the face opening 19 of the head portion 12 of the fire resistant hood element 10 to the center along the firefighter's sternum.

The hood fastener 21 is attached on the interior to the two side panels of the head portion 22 and 23 and the anterior top panel 25 using Nomex® brand or other fire resistant thread. The hood fastener 21 of the fire resistant hood element 10 is attached in an inward facing direction to facilitate interface with the mask fastener 29 of the mask element 11. In a preferred embodiment, both the hood fastener 21 and the mask fastener 29 are made from hook and loop fasteners such as Velcro® brand. In another preferred embodiment, both the hood fastener 21 and the mask fastener 29 are made from male and female snaps which are aligned to receive each other.

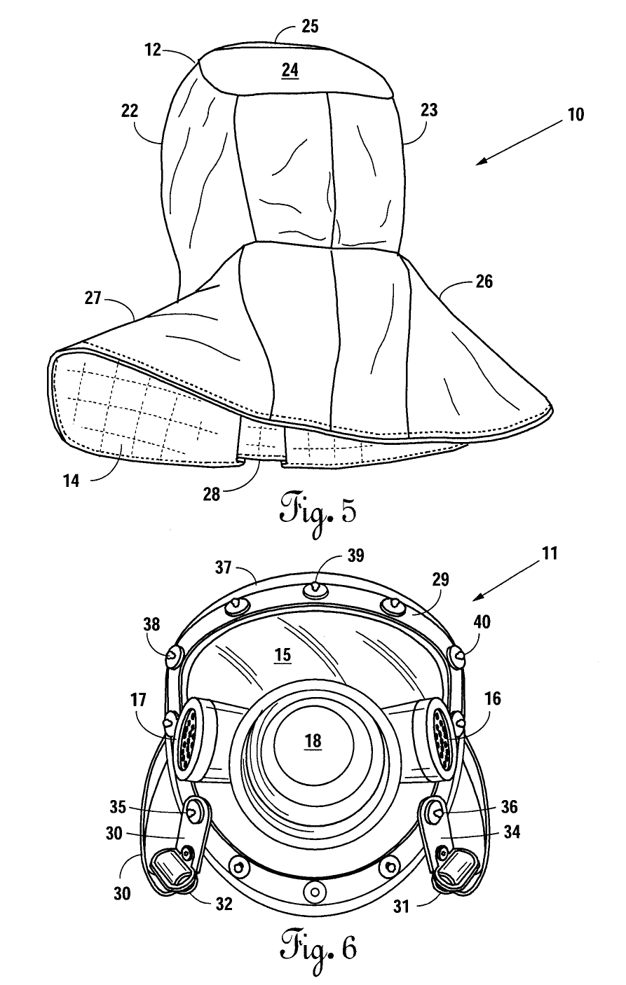

FIG. 5 shows a rear view of the hood element. The figure shows the fire resistant hood element 10 comprising a head portion 12 and a shoulder portion 14 extending below the head portion 12 from the neck join 13. Also visible in the rear view of the hood element is the interior fire resistant lining 41.

The panels of the head portion 12 of the hood element vary in size and are arranged in such a manner as to form the shape of the head portion 12 as described above. Two equal sized side panels 22 and 23 are placed on either side of the face opening and extend upward vertically where they join the top center panel 24 and the anterior top panel 25 and downward to the neck join 13 where they join the shoulder panels 26 and 27. The top of the head portion 12 of the fire resistant hood element 10 is comprised of two panels 24 and 25. One top center 24 panel covers the majority of the top center of the head portion 12 of the fire resistant hood element 10, extending horizontally from the rear of the hood element toward the face opening 19 where it joins the anterior top panel 25 which extends downward to the face opening 19. The back section of the head portion 12 of the fire resistant hood element 10 is comprised of two equally sized back panels, the left back head panel 42 and the right back head panel 43. Each back head panel 42 and 43 joins a side panel 22 and 23 vertically along one edge, the top center panel 24 horizontally along the top edge, the shoulder portion 14 of the fire resistant hood element 10 horizontally along the bottom edge at the neck join 13, and the other back panel, vertically along one edge.

The shoulder portion 14 of the fire resistant hood element 10 is comprised of integral and continuous panels which extend from the neck join 13 where they are joined with the head portion 12. The shoulder panels are arranged about the fire resistant hood element 10 extending from the neck join 13. The two side shoulder panels 26 and 27 extend from where they are joined to the two side head panels 22 and 23 at the neck join 13. The fabric comprising the side shoulder panels 26 and 27 flares as it extends downward to accommodate the shoulders of the firefighters The two back shoulder panels 44 and 45 of the shoulder portion 14 are of a similar in size and dimension to the two back head panels 42 and 43 of the head portion 12. The two back shoulder panels 44 and 45 extend downward from where they are attached to the two back head panels 42 and 43 of the head portion 12 at the neck join 13 of the fire resistant hood element 10. Each back shoulder panel 44 and 45 joins a back head panel 42 and 43 horizontally at the top, a side shoulder panel 26 and 27 vertically on one side and the other back shoulder panel vertically on the other side. The bottom of each back shoulder panel 44 and 45 is hemmed and not joined with anything. The two side shoulder panels 26 and 27 join each other under the face opening 19 of the head portion 12 of the fire resistant hood element 10 to the center along the firefighter's sternum.

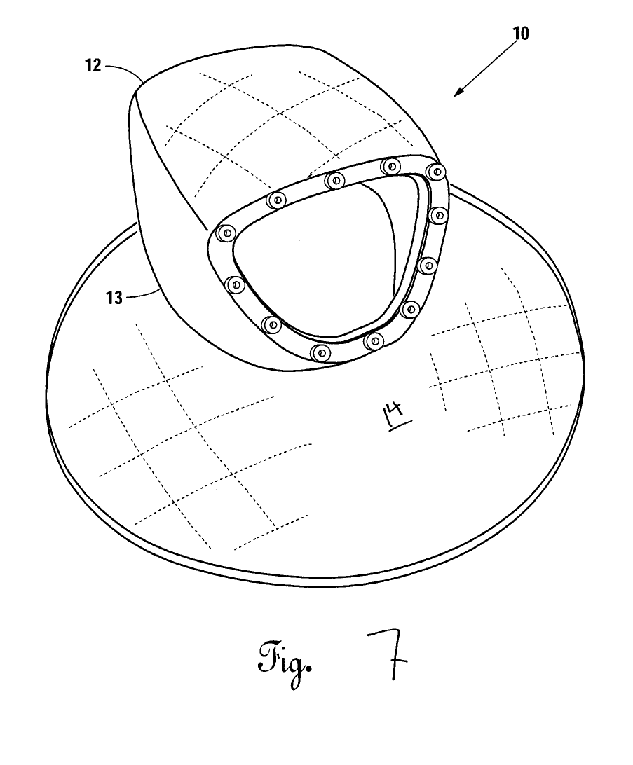

FIG. 6 shows an alternate embodiment of the conventional mask element 11 of the invention in detail. The mask element 11 comprises a transparent face portion 15, two voice transmitters 16 and 17 on opposite sides of the mask element 11, and an SCBA opening 18 for insertion of a SCBA regulator. The conventional mask element 11 comprises new snap mask fasteners 46 which replace the forehead screws and chin bracket screws disclosed above in FIG. 2. The snap mask fasteners 46 can be either male or female depending on the receiving snap type. The snap mask fasters 46 are arranged about the mask element 11 in an evenly spaced manner. In the preferred embodiment, the edge of the mask element 11 contains twelve snap mask fasteners 46. The new snap mask fasteners 46 for the mask element 11 interface with mating snap hood fasteners 47 on the interior of the fire resistant hood element 10 at the mask/hood interface 20.

The mask element 11 also encompasses a conventional mesh head harness which is not pictured and a head strap 30. The transparent face portion 15 of the mask element 11 is constructed from conventional heat resistant plastic material to maximize both fire resistance and visibility. The head strap 30 is made adjustable by threading the head strap 30 through metal clips 31 and 32 which are affixed to both ends of the head strap 30. The metal clips 31 and 32 are affixed so that the clips can slide along the head strap 30 allowing the head strap's 30 length to be adjusted in a range from a full extension to fifty-percent therof. The head strap 30 is attached to the edge of the face mask 37 using metal brackets 33 and 34 which are screwed into the face mask with metal screws which are adapted to act as mask fasteners or are affixed with mask fasteners 46. The edge portion 37 of the mask is designed to create a seal with the firefighter's face to prevent smoke from reaching the firefighter's nose and mouth. The edge portion 37 of the face mask is shaped to fit around the firefighter's face. Accordingly, the edge portion 37 is larger at the top forehead portion of the mask element 11 and narrows toward the bottom chin portion of the mask element. The edge portion of the mask 37 is overlapped by the transparent face portion of the mask 15 on the edges of the transparent face portion 15. A regulator and a conventional oxygen tank may be attached to the mask element 11 at SCBA opening 18 for extending breathing during exposure to smoke and other lung damaging conditions.

The head strap 30 is attached to the mask element 11 at the chin area of the mask element 11 using plastic and metal fasteners which are adapted to which are permanently affixed through the lower chin portion of the mask element 11. The mesh head harness, which is not pictured, is attached to the mask element 11 using plastic and metal screws which are permanently affixed through the upper forehead portion of the mask element 11 and are adapted to contain or are affixed with snap mask fasteners 46. These screws also serve to attach the face mask edge 37 with the transparent face portion 15 of the mask element 11. The voice transmitters 16 and 17 are located on opposite sides of the SCBA opening 18 and are utilized to allow a firefighter to communicate through their mask.

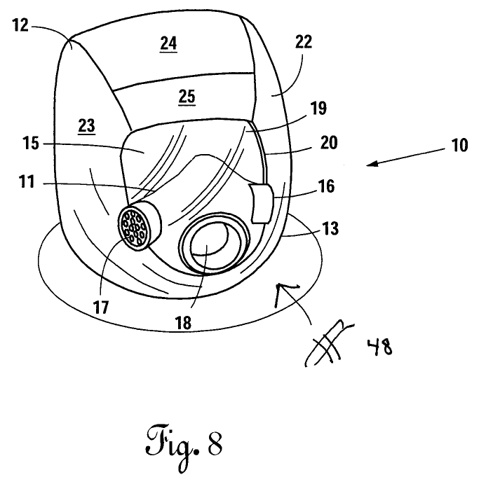

FIG. 7 shows an inside-out view of an alternate embodiment of the fire resistant hood element 10. This figure shows the interior of the fire resistant hood element 10 comprising a head portion 12 and a shoulder portion 14 extending below the head portion 12 from the neck join 13. The head portion 12 of the fire resistant hood element 10 contains a face opening 19 to accommodate the mask element 11 shown in FIGS. 6. The inside-out view of the fire resistant hood element 10 as shown in FIG. 7 demonstrates the snap hood fasteners 47. The snap hood fasteners 47 interface with the snap mask fasteners 46 to removably attach the fire resistant hood element 10 with the mask element 11 and seal and secure the mask with the hood. In the preferred embodiment, the fire resistant hood element 10 should contain an equal number of snap hood fasteners 47 as the mask contains snap mask fasteners 26 in corresponding locations. The snap hood fasteners 47 may be either male or female so long as they are adapted for receiving the snap mask fasteners 46. In the preferred embodiment, the fire resistant hood element 10 contains twelve snap hood fasteners which are arranged evenly about the face opening 19 of the fire resistant hood element 10 in locations which correspond to the snap mask fasteners 46 arranged about the mask element 11. In the preferred embodiment, the interior of the hood element is lined with a lining of Nomex® brand or other fire resistant fabric 41.

FIG. 8 shows an alternate embodiment of the invention generally including both the fire resistant hood element 10 and the mask element 11. The fire resistant hood element 10 is comprised of multiple layers of Nomex® brand or other fire resistant fabric and is generally comprised of an integral head portion 12 and shoulder portion 48 attached to the head portion 12 at the neck join 13. The head portion 12 is shaped to accommodate the head and neck of the firefighters In the alternate embodiment shown in FIG. 8, the shoulder portion 48 is designed to extend only one to five inches below the neck join 13 over only a portion of the firefighter's shoulders, chest and back. The head portion 12 and shoulder portion 48 are attached at the neck join 13. The integral shoulder portion 48 provides enough coverage to lay outside and on top of the firefighter's coat at the firefighter's option. It also can be tucked inside the coat. The mask element 11 is a standard firefighters mask or breathing device adapted to be removably securable and sealable to the fire resistant hood element 10.

The standard mask element 11 is comprised of a transparent face portion 15, two voice transmitters on either side of the mask 16 and 17, and an opening for insertion of a SCBA regulator 18. The head portion 12 of the fire resistant hood element 10 includes a face opening 19 to accommodate the mask element 11.

The conventional mask element 11 and new fire resistant hood element 10 are secured at the mask/hood interface 20 with fastener elements, the hood fastener 21 and the mask fastener 29. In one preferred embodiment, both fasteners 21 and 29 are Velcro® brand hook and loop fasteners. In another preferred embodiment, both fasteners 21 and 29 are snap fasteners.

In the preferred embodiment, the head portion 12 is comprised of integral panels of Nomex® brand or other fire resistant material stitched together using Nomex® brand or other fire resistant thread. The multiple layers of fire resistant material will resist high temperatures for a limited amount of time and protect the fire fighter from heat and burning. The panels comprising the head portion 12 of the fire resistant hood element 10 extend downwards to the neck join 13 of the fire resistant hood element 10 where they attach to the panels comprising the shoulder portion 48 of the fire resistant hood element 10. The shoulder portion 48 extends from the head portion 12 at the neck join 13 and flares outwards at a consistent angle from the neck join 13. In the embodiment illustrated in FIG. 8, the shoulder portion 48 of the fire resistant hood element 10 extends out one to five inches from the neck join 13 to cover a portion of the firefighter's shoulders, back and chest. The shoulder portion 48 of the fire resistant hood element 10 is comprised of panels of Nomex® brand or other fire resistant material stitched together using Nomex® brand or other fire resistant thread.

The panels comprising the head portion 12 of the hood element vary in size and are arranged in such a manner as to form the shape of the head portion 12 as described above. Two equal sized side panels 22 and 23 are placed on either side of the face opening and extend upward vertically where they join the top center panel 24 and the anterior top panel 25 and downward to the neck join 13 where they join the shoulder panels 26 and 27. The shoulder panels 26 and 27 and back panels form a continuous wrap around the shoulders, back and front of the firefighter so that there are no gaps that would allow exposure of the firefighter's head.

The top of the head portion 12 of the fire resistant hood element 10 is comprised of two panels 24 and 25. One top center 24 panel covers the majority of the top center of the head portion 12 of the fire resistant hood element 10, extending horizontally from the rear of the hood element toward the face opening 19 where it joins the anterior top panel 25 which extends downward to the face opening 19. The back section of the head portion 12 of the fire resistant hood element 10 is comprised of two equally sized back panels, the left back head panel 42 and the right back head panel 43. The left back head panel 42 joins the right side panel 22 of the head portion 12 vertically along the left edge, the top center panel 24 horizontally along the top edge of the left back head panel 42, the left shoulder back panel 44 of the shoulder portion 14 of the fire resistant hood element 10 horizontally along the bottom edge of the left back head panel 42 at the neck join 13, and the right back head panel 43 vertically along the right edge of the left back head panel 42. The right back head panel 43 joins the left side panel 23 of the head portion 12 vertically along the right edge, the top center panel 24 horizontally along the top edge of the right back head panel 43, the right shoulder back panel 45 of the shoulder portion 48 of the fire resistant hood element 10 horizontally along the bottom edge of the left back head panel 42 at the neck join 13, and the left back head panel 42 vertically along the left edge of the right back head panel 43.

The shoulder portion 48 of the fire resistant hood element 10 is comprised of continuous panels with no gaps which extend from the neck join 13 where they are joined with the head portion 12. The shoulder panels are arranged about the fire resistant hood element 10 extending from the neck join 13.

The hood fastener 21 is attached on the interior to the two side panels of the head portion 22 and 23, and the anterior top panel 25 using Nomex® brand or other fire resistant thread. The hood fastener 21 of the fire resistant hood element 10 is attached in an inward facing direction to facilitate interface with the mask fastener 29 of the mask element 11. In one preferred embodiment, both the hood fastener 21 and the mask fastener 29 are hook and loop fasteners such as Velcro® brand. In the alternate preferred embodiment, the hood fastener 21 and the mask fastener 29 comprise snap fasteners.

Before concluding, it is to be understood that the terminology employed in this application is for the purpose of describing particular embodiments. Unless the context clearly demonstrates otherwise, it is not intended to be limiting. In this specification and the appended claims, the singular forms “a,” “an” and “the” include plural references unless the context clearly dictates otherwise. Conversely, it is contemplated that the claims may be drafted to exclude any optional element or be further limited using exclusive terminology as “solely.” “only” and the like in connection with the recitation of claim elements or by use of a “negative” limitation. It is also contemplated that any optional feature of the inventive variations described herein may be set forth and claimed independently, or in combination with anyone or more of the features described herein.

Although the foregoing specific details describe various embodiments of the invention, persons reasonably skilled in the art will recognize that various changes may be made in the details of the apparatus of this invention without departing from the spirit and scope of the invention as defined in the appended claims. Therefore, it should be understood that, unless otherwise specified, this invention is not to be limited to the specific details shown and described herein.

1. A fire fighters fire resistant hood, for attaching to a fire fighters face mask comprising:
a fire resistant head portion for fitting over a firefighter's head and neck and having a face opening;
a fire resistant continuous shoulder portion extending around a firefighters shoulders, back and chest and integrally secured to the head portion;
a fastener means secured to the inner periphery of the face opening of the fire resistant head portion for securing to a fastening means on a fire resistant face mask to form a fire resistant seal and protect a firefighter from injury and death from a fire.

2. The fire fighters fire resistant hood of claim 1 wherein the fastening means comprises hook and loop fasteners.

3. The fire fighters fire resistant hood of claim 1 wherein the fastening means comprises snap fasteners.

4. A method of attaching a fire fighters fire resistant hood to a fire fighters fire resistant face mask comprising:
fitting a fire resistant head portion over firefighter's head and neck and having a face opening and a continuous fire resistant shoulder portion extending around a firefighters shoulders, back and chest and integrally secured to the head portion;
securing the inner periphery of the face opening with securing means to a fastening means on a fire resistant face mask to form a seal and protect a firefighter from injury and death from a fire.

5. The method of claim 3 including the step of securing the inner periphery of the face opening to the fire resistant face mask with hook and loop fasteners.

6. A fire fighters fire resistant hood, for attaching to a fire fighters face mask comprising:
a fire resistant head portion for fitting over a firefighter's head and neck and having a face opening;
a fire resistant continuous shoulder portion extending between one and five inches from the head portion and integrally secured to the head portion;
a fastener means secured to the inner periphery of the face opening of the fire resistant head portion for securing to a fastening means on a fire resistant face mask to form a fire resistant seal and protect a firefighter from injury and death from a fire.

7. The fire fighters fire resistant hood of claim 6 wherein the fastening means comprises hook and loop fasteners.

8. The fire fighters fire resistant hood of claim 6 wherein the fastening means comprises snap fasteners.
